(19) United States
(12) Patent Application Publication
(10) Pub. No.: US 2008/0029639 A1
(43) Pub. Date: Feb. 7, 2008

(54) Device For Winding And Unwinding Of Hoses, Cables Or The Like

(76) Inventor: Livin Fernand Georges Dethier, Alken (BE)

Correspondence Address: BACON & THOMAS, PLLC, 625 SLATERS LANE, FOURTH FLOOR, ALEXANDRIA, VA, 22314, US

(21) Appl. No.: 11/579,808

(22) PCT Filed: May 3, 2005
(86) PCT No.: PCT/BE05/00067

§ 371 Date: Nov. 7, 2006

(30) Foreign Application Priority Data
May 10, 2004 (BE) 2004/0228

(51) Int. Cl. B65H 75/18; B62B 1/00; B65H 75/24

(52) U.S. Cl. 242/603; 280/47.17

(57) ABSTRACT

Device for winding and unwinding hoses, cables or the like, which device (1) mainly consists of a wheeled undercarriage (2) with a support (6), whereby suspension means (9) are provided on the above-mentioned support (6) in the shape of at least two fixed guides (10 and 11), which are each made in the shape of a bent element (12), and whereby these bent elements (12) are directed with their hollow sides towards each other, whereby the above-mentioned bent elements (12) are confined by at least one upward or downward directed partition (13) which is practically parallel to the support (6) and whereby intermediate partitions (14) are provided on these elements (12) as well.

The present invention concerns a device for winding and unwinding hoses, cables or the like.

On construction sites or the like it is often found, in practice, that hoses, cables and the like are often left lying about on the ground, which entails a considerable risk of people tripping over them. It is also found that gathering loose, often very heavy hoses or cables is difficult and puts a heavy load on the back.

Devices in the form of what are called reels are already known, which mainly consist of a wheeled undercarriage, onto which is provided a rotatable drum for winding and unwinding a garden hose or the like.

A disadvantage of such known reels is that they are relatively sizeable due to the presence of the above-mentioned drum and that the construction of such reels is relatively complex, as a result of which the assembly thereof takes much time.

Another disadvantage of such known reels is that they are not fit for winding very long and/or thick hoses or the like, since the dimensions of the above-mentioned drum are very large then, as a result of which such reels are then unmanageably large and heavy and are difficult to put away.

Another disadvantage of such known reels is that relatively much material is required to manufacture such drums, as a result of which the cost price of such reels is relatively high.

An additional disadvantage of the known reels is that, if the above-mentioned drum is small, electric cables and the like, after having been unwound, still have loops, which is inconvenient and which may result in knots.

Another additional disadvantage of the known wheeled reels is that the hose or cable must lie straight in order to be able to wind it properly and to avoid that the hose or cable becomes entangled.

Another disadvantage of the known reels for electric cables is that, while in use, when a considerable amount of the cable is still wound on the drum, this cable may become very hot, since the part of the cable which is wound against the drum, cannot give off sufficient heat to the environment, as a result of which the cable or the reel may be damaged due to overheating.

Another disadvantage of the known reels is that they are provided with moving parts which are liable to wear.

The present invention aims to provide a solution to one or several of the above-mentioned and other disadvantages.

To this end, the invention concerns a device for winding and unwinding hoses, cables or the like, which device mainly consists of a wheeled undercarriage upon which is provided an upward directed support, whereby suspension means are provided on the above-mentioned support in the shape of at least two fixed guides, which are each made in the shape of a bent element, and whereby these bent elements are directed with their hollow sides towards each other and are provided at a distance from each other on the support, and can support the above-mentioned hoses and/or cables in at least two places situated at a distance from each other, whereby the above-mentioned bent elements are confined by one or two upward or downward directed partitions which are parallel, or almost parallel to the support, and whereby also intermediate partitions are provided on these elements.

An advantage thereof is that a device is obtained whose construction is very simple and compact and which can be quickly assembled.

Another advantage of such a device according to the invention is that it is extremely suitable for winding very long cables, since the dimensions of the suspension means can be restricted, as a result of which such a device according to the present invention is easy to handle and light, and as a result of which such a device can be easily stored.

Another advantage of such a device according to the present invention is that, for manufacturing such suspension means, little material is required, as a result of which the cost price of such a device according to the invention is low.

An additional advantage is that electric cables and the like can be wound over a larger girth, such that, after having been unwound, they will not show any loops, and as a result of which the risk of hindrance caused by knots or the like decreases.

Another additional advantage of a device for winding and unwinding hoses, cables or the like, is that the hose or cable must not lie straight in order to be able to wind it properly, as the hose or cable can be wound up manually.

Another advantage is that, with a device according to the present invention, also very heavy cables and/or hoses can be wound in a simple manner.

Another additional advantage of such a device according to the invention is that the hoses or the like which are wound with such a device can be pulled taut around the top and bottom guide, as a result of which the hoses or the like can be wound in a very compact manner, and space can be saved widthwise in relation to the known devices with a drum.

Thanks to the presence of the partitions, cables, hoses and the like can be stored in a fixed manner, such that falling off and lying about can be avoided and the risk of entanglements decreases.

By means of the above-mentioned intermediate partitions, also several cables or the like can be wound on a device according to the invention, whereby, if necessary, a partition can be provided between different cables.

The present invention also concerns a device for winding and unwinding hoses, cables or the like, which device mainly consists of a wheeled undercarriage upon which is provided an upward directed support, whereby suspension means are provided on the above-mentioned support in the shape of at least two guides, which are each made in the shape of an element and whereby these elements are provided at a distance from each other on the support, and can support the above-mentioned hoses and/or cables in at least two places situated at a distance from each other, having as a special characteristic that the above-mentioned elements are confined by one or two partitions which are parallel or almost parallel to the support, and that also intermediate partitions are provided on these elements.

Thanks to the presence of the partitions, cables, hoses and the like can be stored in a fixed manner with such a device as well, such that falling off and lying about is avoided and the risk of entanglements decreases.

By means of the above-mentioned intermediate partitions, also several cables or the like can be wound on a device according to the invention, whereby, if necessary, a partition can be provided between different cables.

Such a device also has a very simple and compact construction, and it can be quickly assembled.

By making the above-mentioned guides rotatable, for example, a hose, cable or the like can be wound in a simple manner.

In order to better explain the characteristics of the invention, the following preferred embodiments of a device according to the invention for winding and unwinding hoses, cables or the like, are given as an example only without being limitative in any way, with reference to the accompanying drawings, in which:

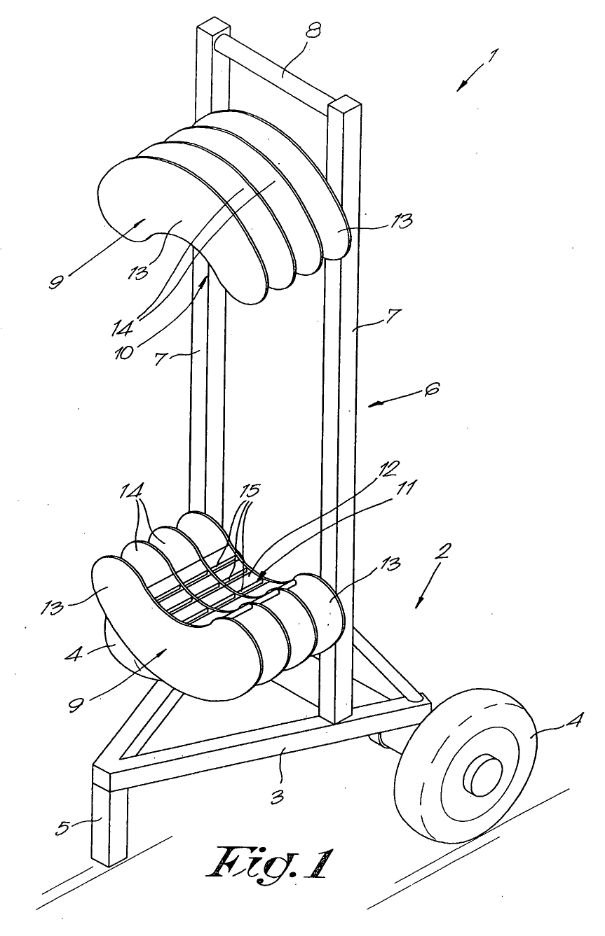

FIG. 1 schematically represents a device according to the invention in perspective;

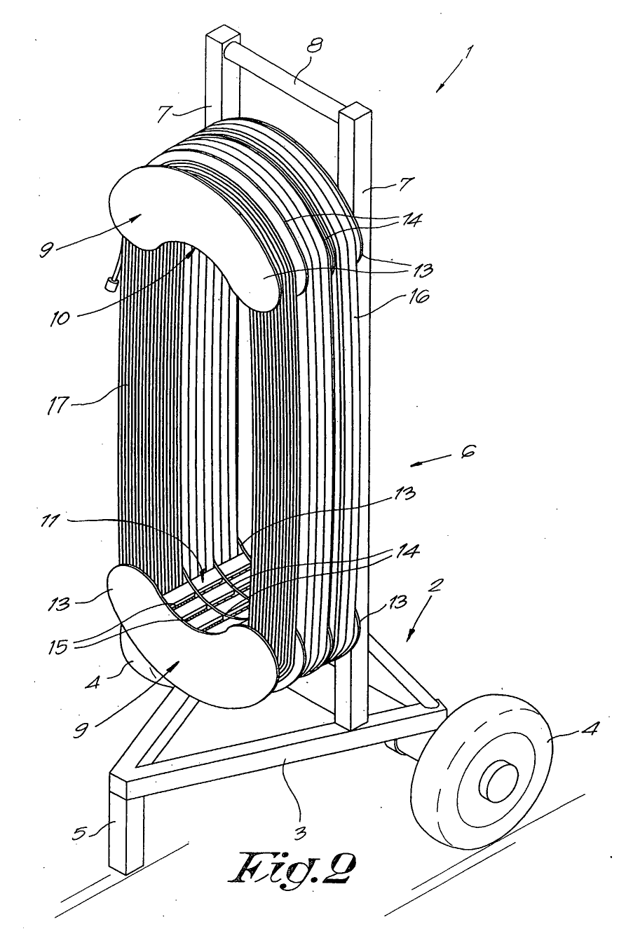

FIG. 2 represents the use of a device according to FIG. 1;

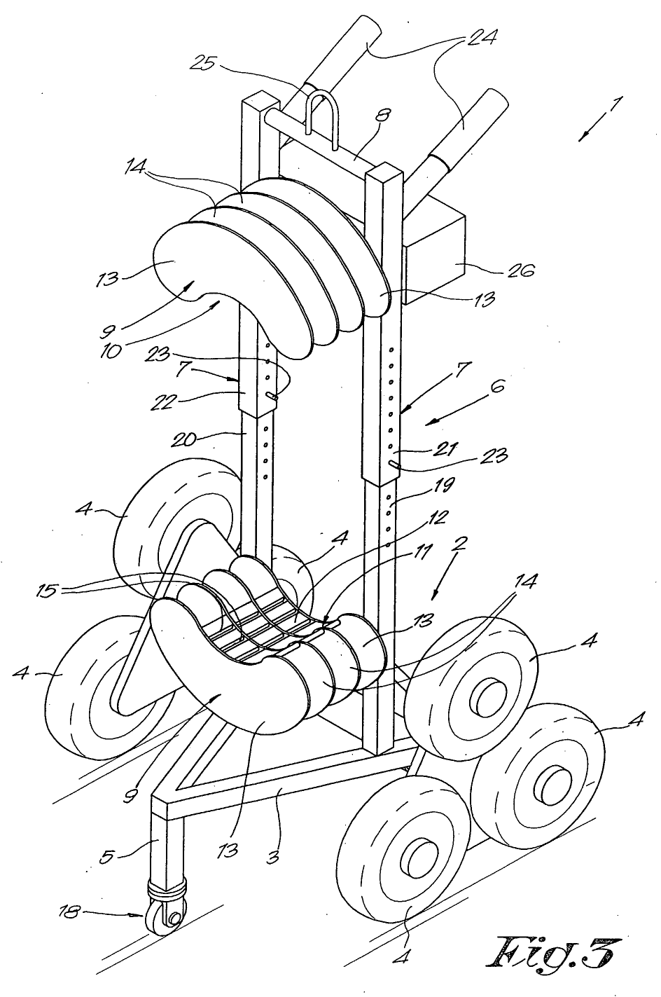

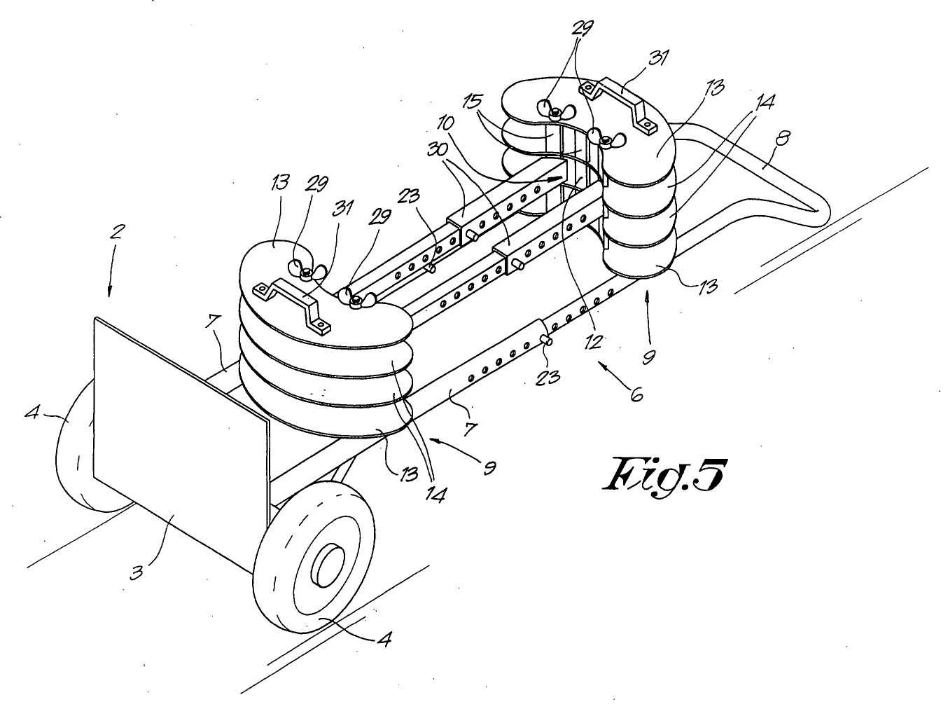

FIGS. 3 to 5 represent variants of a device according to FIG. 1, whereby the variant of FIG. 5 is represented in another position;

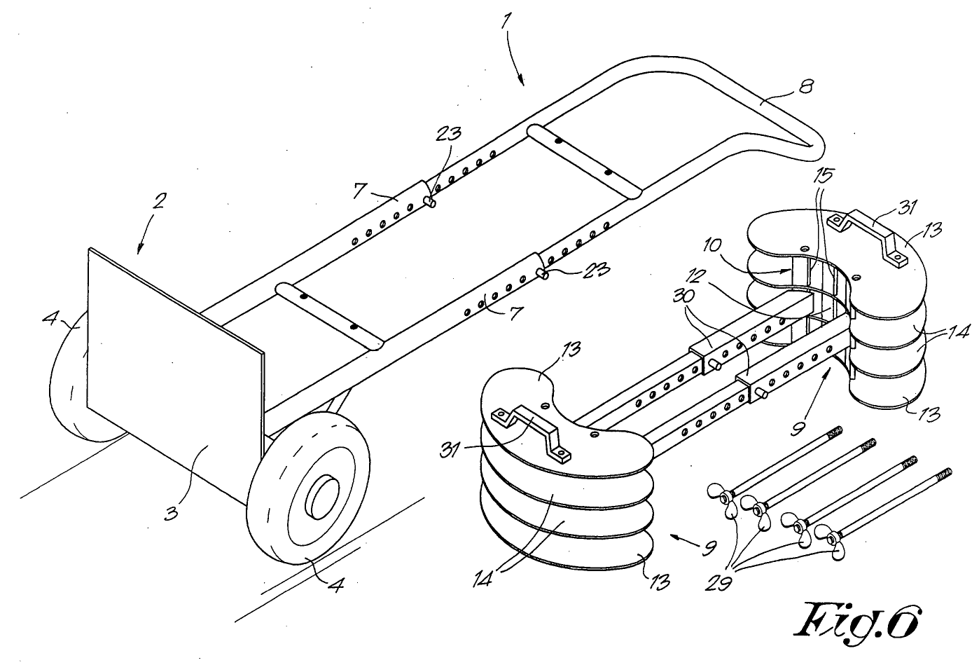

FIG. 6 represents the use of a device 5 according to FIG. 5;

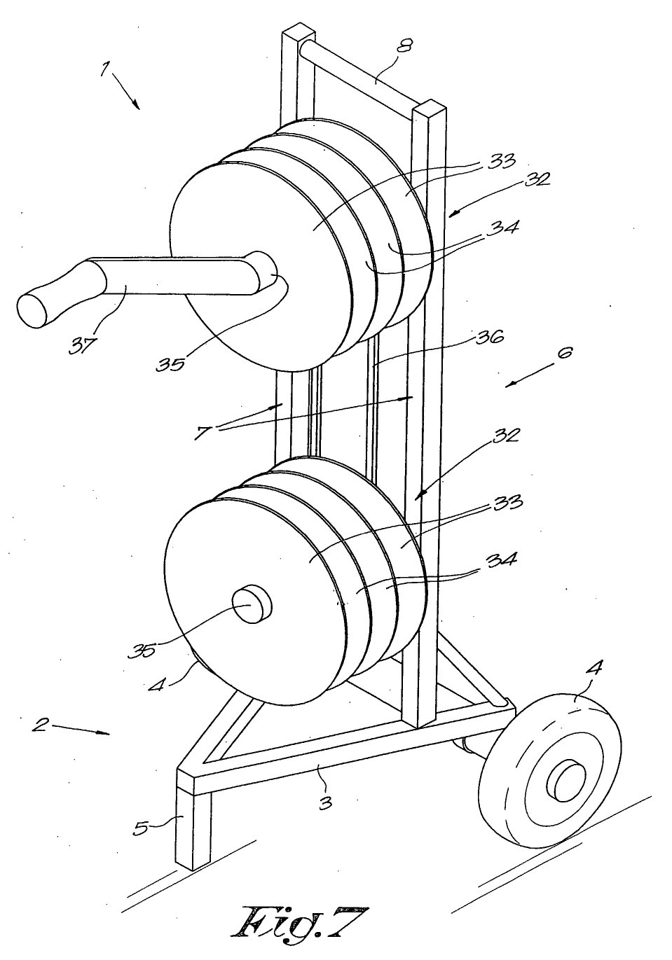

FIG. 7 represents another embodiment of a device according to the invention according to FIG. 1.

FIG. 1 represents a device 1 according to the invention which mainly consists of an undercarriage 2 which is built up of a base 3 upon which are provided, in this case, two wheels 4 and a supporting leg 5.

On the above-mentioned base 3 is also provided an upward directed support 6, in this case of two pipes 7 running parallel which are connected at their free ends by means of a connecting rod 8, which in this case also forms a handle.

On the above-mentioned support 6 are provided suspension means 9, one on top of the other, between the above-mentioned pipes 7, in the shape of an upper fixed guide 10 and a lower fixed guide 11.

It is clear that the above-mentioned suspension means 9 can also be provided on the above-mentioned, support 6 such that they can be removed and put back.

Each of the above-mentioned guides 10-11 consists in this case of a bent element 12 which is confined by two upward, two downward directed partitions 13 respectively, which are parallel or practically parallel to the support 6.

Between the above-mentioned partitions 13 are also provided intermediate partitions 14 according to the invention, which can preferably but not necessarily be provided at variable intermediate distances on the above-mentioned guides 10-11 by means of adjusting means which are not represented in the figures, but which are known as such.

The above-mentioned partitions 13 and/or intermediate partitions 14 can preferably be removed and put back on the above-mentioned guides 10-11, for example by means of a snap-in connection or the like.

The above-mentioned bent elements 12 are provided crosswise on the above-mentioned support 6, and the hollow sides of these bent elements 12 are directed towards each other.

In the bent elements 12 are also provided one or several recesses 15. It is clear that such recesses 15 can also be provided in the above-mentioned partitions 13.

The use of such a device according to the invention is very simple and is represented in FIG. 2.

For winding and unwinding a hose 16 or the like on the device 1, the hose 16 must be wound manually over the above-mentioned upper and lower guides 10-11, whereby the above-mentioned partitions 13 make sure that the hose 16 is retained on the guides 10-11.

If different cables, hoses or the like must be wound on the device 1, they can be kept apart by means of the above-mentioned intermediate partitions 14, as represented in the figure, whereby a cable 17 is wound separately around the guides 10-11.

If necessary, it is also possible, according to the invention, to remove one or several of the above-mentioned intermediate partitions 14, for example, or to adjust the mutual distance between the respective intermediate partitions 14.

For winding and unwinding very long cables 17 or the like, the device 1 according to the invention can be wheeled, making use of the connecting rod 8 forming a handle, whereby the device 1 is kept slantingly backward, such that the above-mentioned supporting leg 5 is lifted. The above-mentioned device 1 can hereby be moved along the trajectory of the unwound cable 17 or the like, while the cable 17 is wound or unwound manually around the above-mentioned guides 10-11.

The recesses 14 in the above-mentioned bent elements 9 make it possible for dirt and the like, sticking to a cable 17 or hose 16 to be wound, to drop through said recesses 14. Said recesses 14 also make sure that heat of for example electric cables 17 can be easily given off to the environment.

FIG. 3 represents a variant of a device 1 for winding and unwinding hoses 16 and the like according to the invention.

This variant differs from a device according to FIG. 1 in that the above-mentioned wheels 4 are made in the form of what are called step wheels which are each formed of three wheels respectively provided in a triangular bracing on a plate which is fixed to the base 3 in a rotatable manner. The above-mentioned supporting leg 5 has been replaced by a swivel castor 18.

The above-mentioned support 6 is hereby made telescopic, as it is formed of lower pipes 19-20 over which two upper pipes 21-22 are provided in a sliding manner. On the above-mentioned support 6 are also provided locking means 23.

This embodiment is also provided with handles 24 which are provided on each of the above-mentioned upper pipes 21-22 and which extend slantingly in relation to the above-mentioned support 6.

On the above-mentioned connecting rod 8 is provided a crane hook 25, for example in the shape of a metal ring or the like.

At the height of the upper guide 10 of the suspension means 9 are provided connecting means 26 for one or several hoses 16, cables 17 or the like, which connecting means 26 are preferably made such that they can be removed and placed back.

The use of such a variant embodiment is analogous to the one described above, but such a variant of a device 1 according to the invention can also be moved over stairs, steps and the like, by means of the above-mentioned step wheels.

Thanks to the presence of the swivel castor 18, such a variant device 1 according to the invention is more manoeuvrable than the preceding embodiment.

The above-mentioned upper guide 10 is hereby adjustable in height, thanks to the pipes 19-20-21-22 which are adjustable in height, such that the device 1 can be made suitable for cables 17 with different lengths and diameters, by adjusting the mutual distance between the guides 10-11.

In the known manner, the above-mentioned connecting means are made in the shape of a distributing board or a combination of two or several distributing boards for, for example, electric, pneumatic and/or hydraulic connections, and if necessary they can be removed and/or replaced by other connecting means 26, such that a modular system is formed which can be used for several applications, such as, for example, for high-voltage and low-voltage applications.

By means of the above-mentioned crane hook 25, the device 1 according to the invention can be lifted in the known manner by means of a crane or the like.

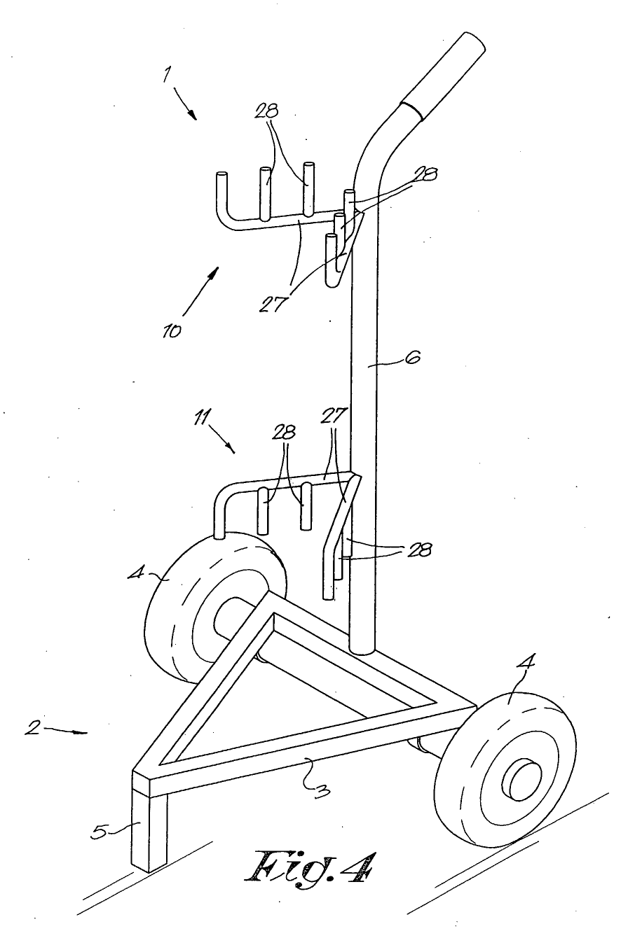

FIG. 4 represents another variant of a device 1 according to the invention, whereby the above-mentioned support 6 is made in the shape of a single central standing pipe, upon which guides 10-11 are provided which for example each consist of two pairs of hooks 27 which are placed on top of each other, and whereby the lower pair of hooks and the upper pair of hooks are directed away from each other.

The advantage thereof is that a relatively wide guide can be obtained with very little material, as a result of which such a device 1 according to the invention is cheap, and whereby it is nevertheless avoided that hoses or the like are locally squeezed due to too sharp bends in the wound hose at the height of the suspension means 9.

In this case, intermediate hooks 28 which can be either or not removed and placed back and/or which are adjustable are also provided on the above-mentioned hooks 27, as a result of which cables, hoses or the like can be wound on this device 1.

It goes without saying that, if required, partitions 13 and/or intermediate partitions 14 which can be either or not removed and placed back can be provided on said hooks 27.

The use of such a variant of a device 1 according to the invention is analogous to the above-described embodiments.

FIG. 5 represents another variant of a device 1 according to the invention.

The handle of this variant device 1 is formed of a connecting rod 8, whereby the top part of the support 6 is bent, such that when the device 1 is laid flat, the above-mentioned handle forms a point of support on the ground, which makes the winding and unwinding of the hoses 16, cables 17 or the like easier.

The front partitions 13, and if necessary also the intermediate partitions 14, can in this case be removed and placed back on the above-mentioned bent elements 12, by means of wing nuts 29.

It is clear that numerous other fastening manners are possible for these partitions 13 and for the intermediate partitions 14, such as for example an ordinary bolt connection, a clip connection, or the like.

The above-mentioned guides 10-11 are in this case connected to each other by means of two rods 30 which are provided on these guides 10-11 in an either or not easily removable manner and which are telescopically adjustable in this case.

The guides 10-11 can also be removed from the above-mentioned support 6. To this end, a handle 31 is provided on two of the partitions 13 as well in this case.

It is clear that the presence of this handle 31 according to the invention is not strictly required, and that it can also be provided on one or several of the above-mentioned guides 10-11 or on intermediate partitions 14.

In this case, the above-mentioned base 3 is made in the shape of a flat supporting plate which can be used for example to transport large and/or heavy objects.

On the guides 10-11 and/or on the partitions 13 are also provided suspension means which are not represented in the figures.

Such an embodiment of a device 1 according to the invention makes it possible to remove the whole of the rods 30 and the guides 10-11 from the support 6, as represented in FIG. 6, and to hang them for example on a wall or the like by means of the above-mentioned suspension means.

If required, the whole can also be stacked, such that space can be saved when storing hoses, cables or the like.

If necessary, the above-mentioned suspension means can also be made such that they can also be used to fix the rods 30 and the guides 10-11 as a whole on the support 6, such that they can be removed and placed back.

FIG. 7 represents another embodiment of a device 1 according to the invention whereby the above-mentioned guides are made in the shape of wide rotatable wheels 32 which are confined by partitions 33 and which are also provided with intermediate partitions 34 which may be provided on the wheels 32, if necessary, in such a manner that they can be removed and placed back.

The above-mentioned wheels 32 are in this case provided on the support 6 such that they can each rotate around a shaft 35, and they are connected to each other for example by means of a belt 36, a chain or the like.

On at least one of the above-mentioned wheels 32 is in this case provided a crank 37 which makes the winding and unwinding of a hose 16 or the like considerably easier.

According to a variant of a device according to the invention which is not represented in the figures, the whole of the rods 30 and the guides 10-11 can be provided on the device 1 in a rotatable manner by means of a shaft placed on the above-mentioned support 6, preferably in the middle, such that, when winding and unwinding a hose, cable or the like, these guides can be wound around the above-mentioned shaft, such that the operation of winding and unwinding is made easier.

It is clear that the wheels 4 can be provided with pneumatic tyres as well as with full tyres.

It is also clear that means can be provided for tying up the windings of the hose or the like which is wound on a device according to the invention, such that when moving the device, the hose is prevented from coming off, getting entangled or the like.

Naturally, one or several of the above-mentioned guides 10-11 can be provided on the support 6 such that they can be adjusted in height.

It is not excluded, according to the invention, for the above-mentioned support 6 to be adjustable in different angles in relation to the wheeled undercarriage 2.

A device 1 according to the invention can also be made in the shape of a do-it-yourself package.

It is also possible, according to the invention, to provide a storage box on the device 1, which can be either or not removed and placed back, for storing tools or the like.

The present invention is by no means restricted to the embodiments given as an example and represented in the accompanying drawings; on the contrary, such a device 1 for winding and unwinding hoses 16, cables and the like according to the invention, can be made in all sorts of shapes and dimensions while still remaining within the scope of the invention.

1. Device for winding and unwinding hoses, cables or the like, comprising a wheeled undercarriage upon which is provided an upward directed support; a suspension device in the form of at least two fixed guides located on the support, said guides each made in the shape of a bent element having a concave side, and wherein the bent elements are directed with their concave sides facing towards each other and are located on the support at a distance from each other, and are arranged so as to support hoses and/or cables in at least two locations situated at a distance from each other, and wherein the bent elements are confined by one or two outer upward or downward directed partitions which extend parallel, or practically parallel, to the support, and including intermediate partitions on said elements as well between said outer partitions.

2. Device according to claim 1, wherein two guides are provided one above the other.

3. Device according to claim 1, wherein one or several of the outer partitions and/or intermediate partitions are provided on the guides such that they can be removed and placed back therein.

4. Device according to claim 3, wherein the intermediate partitions are disposed on the guides by means of an adjusting device that enables their spacing at variable intermediate distances.

5. Device according to claim 3, wherein the outer partitions and/or intermediate partitions are connected to the guide by means of a snap-in connection.

6. Device according to claim 1, wherein recesses are provided in the guides.

7. Device according to claim 1, wherein the guides are provided on the support such that they can be removed and placed back on.

8. Device according to claim 7, wherein the guides are connected to each other by means of one or several rods.

9. Device according to claim 1, wherein the guides are mutually adjustable.

10. Device according to claim 8, wherein the rods are telescopic to enable adjustment of the mutual distance between the guides.

11. Device according to claim 8, wherein the rods are provided on the guides such that they can be removed and placed back on.

12. Device according to claim 7, wherein one or several of the guides and/or partitions is provided with at least one handle.

13. Device according to claim 7, wherein on at least one of the guides, a device for hanging on the guides is provided.

14. Device according to claim 7, wherein guides are stackable.

15. Device according to claim 1, wherein one one or several of the guides is provided on the support in a manner such that it can be adjusted in height.

16. Device according to claim 1, including a connecting device for one or several hoses, cables or the like, or a combination thereof.

17. Device according to claim 16, wherein the connecting device can be removed and placed back on.

18. Device according to claim 1, including at least one handle which extends slantingly in relation to the support.

19. Device according to claim 1, wherein the support is telescopically adjustable in height.

20. Device according to claim 1, wherein the wheeled undercarriage is provided with a supporting plate.

21. Device according to claim 1, including a crane hook.

22. Device according to claim 1, including several suspension devices arranged to receive two or more cables.

23. Device according to claim 1, wherein the support is adjustable at different angles in relation to the wheeled undercarriage.

24. Device according to claim 1, arranged as a do-it-yourself package.

25. Device according to claim 1, wherein guides are made in the form of main hooks.

26. Device according to claim 25, including intermediate hooks on the main hooks which are arranged to be removed and placed back on.

27. Device for winding and unwinding hoses, cables or the like, which is hand-operated and comprises a wheeled undercarriage upon which is provided an upward directed support, suspension means in the form of at least two guides on the support, said guides arranged in the shape of an element, and wherein the elements are provided on the support at a distance from each other support the hoses and/or cables in at least two places situated at a distance from each other, wherein the elements are configured with respect to each other in such a manner that said hoses and/or cables when wound thereon are wound-up in an elongated manner for saving space widthwise in relations to devices using a drum, and wherein the elements are confined by one or two partitions which extend parallel, or practically parallel to the support, and wherein intermediate partitions are provided on the elements.

28. Device according to claim 27, wherein the two guides are provided one above the other.

29. Device according to claim 27, including one or several of the outer partitions and/or intermediate partitions are provided on the guide such that they can be removed and placed back on.

30. Device according to claim 27, wherein the guides have the form of wide, rotatable wheels.

31. Device according to claim 30, wherein the rotatable wheels are connected to each other by means of a belt, a chain or the like.

32. Device according to claim 27, wherein the guides are connected to each other by means of one or several rods.

33. Device according to claim 32, wherein the rods and the guides are mounted as a unit in a rotatable manner on the support by means of a shaft.
